(19) United States
(12) Patent Application Publication
(10) Pub. No.: US 2016/0226609 A1
(43) Pub. Date: Aug. 4, 2016

(54) DEVICE AND METHOD FOR REPRODUCING DIGITAL RECEIVER SIGNALS

(71) Applicant: SCHAIDT INNOVATIONS GMBH & CO. KG, Wörth/Schaidt (DE)

(72) Inventor: Stefan Goetz, Gleisweiler (DE)

(73) Assignee: Schaidt Innovations GmbH & Co. KG, Worth-Schaidt (DE)

(21) Appl. No.: 15/021,677

(22) PCT Filed: Sep. 15, 2014
(86) PCT No.: PCT/EP2014/002488

§ 371 Date: Mar. 11, 2016

(30) Foreign Application Priority Data
Sep. 13, 2013 (DE) DE102013015101.5

(51) Int. Cl. H04H 20/62; H04H 20/86

(52) U.S. Cl. CPC H04H 20/62; H04H 20/86; H04H 2201/13; H04H 2201/20

(57) ABSTRACT

The invention relates to a device and method for reproducing digital receiver signals. The claimed invention provides the user with a conventional radio receiver having a universal and comfortable operational concept for reproducing digital receiver signals.

The present invention relates to a device and a method of presenting digital received signals. The present invention provides the user with a conventional radio receiver having a universal and comfortable operational concept for presenting digital received signals.

Conventional radio receivers in vehicles are generally only provided for receiving analogue radio signals, but not for digital radio signals, in particular DRM and DAB. However, it is expensive and laborious to change the analogue radio receivers that exist in large numbers, and so digital radio transmissions have until now only rarely been able to be received by vehicles.

Complete units for analogue and digital reception for mobile road users are currently still not sufficiently available and the developments that have taken place often offer an unfavourable price/performance ratio to many users.

The concept of “interactive RDS broadcast” architecture, also referred to as IRB architecture in the following, that forms the basis of the present invention is based on the object of providing interactive communication and menu management when playing and displaying audio sources via an FM RDS receiver.

FM RDS receivers, which are suitable for implementing the method according to the invention, are known from the prior art—e.g. from European Patent Application 0 333 194. This type of FM (VHF) receiver is embodied by a twin tuner FM RDS receiver with a first or main tuner or a second or auxiliary tuner. The main tuner serves to tune the receiver to a radio transmitter station with a desired audio programme and to process the audio programme signals for the sound reproduction.

If the received transmitter also transmits RDS data, the main tuner additionally extracts the RDS data carried by the received RDS transmitter signal (RDS data telegram), also including among other things a list of alternative frequencies (AFs). This list provides tuning data on transmitter frequencies which carry the same programme as the one to which the receiver is actually tuned.

The format of an RDS data telegram is uniform throughout Europe. In addition to the actual radio signals, additional information is transmitted here that can be evaluated by car radios that have an appropriate RDS decoder. Thus, for example, the name of the received programme can be displayed on a corresponding radio display (PS code).

In order to achieve the object mentioned at the start, the transmitter list of the FM RDS receiver is used in order to be able to display at the same time the audio sources and/or menu functions that can be selected. The degree to which the transmitter list can be displayed and manipulated in a user-friendly and comfortable manner depends on the respective FM RDS receiver.

The length of the transmitter list is only limited by the possible number of transmitters in the VHF band that are capable of receiving; it is therefore unproblematic and does not constitute a restriction for realisation of the present invention.

Due to its basic structure the “interactive RDS broadcast” architecture is based on the following components:
a. administering, sorting and prioritising radio sources
b. real-time MPX encoder with FM modulator
c. real-time sample player
d. real-time adder
e. MPX encoder with reduced RDS information
f. FM modulator
g. memory for the samples
h. adder
i. decoder for the return channel

As regards hardware, the following requirements must be fulfilled:

The FM-modulated signals in the VHF band must be made available to the FM RDS receiver at a level of approx. 50-70 dBμV. The LF (low frequency) outputs of the FM RDS receiver are digitalised and the IF signal (intermediate frequency signal) of the FM RDS receiver can be decoded by the FM RDS demodulator and can be given on the software decoder for the return channel.

Communication according to the “interactive RDS broadcast” architecture according to the invention is implemented as follows. It should first of all be noted that there are at least two versions by means of which communication can be carried out:
1^{st} version: The intermediate frequency is emitted again by the radio and evaluated by the IRB.
2^{nd} version: Clear identification in the audio frequency range is added to the MPX (multiplex) signal, which identification can be evaluated at the final stage outputs from the IRB.

For all pre-selected audio sources the name of the audio source is computed into the MPX signal as a PS code without any audio signal, is frequency-modulated and communicated to the FM RDS receiver. By reducing the scope of the RDS protocol, buffering and condensing the FM signals, the degree of technical complexity can be kept small.

The resulting transmitter list shows all of the PS codes—i.e. the names of the audio sources—as “transmitters” in the FM RDS receiver.

As soon as one of the displayed “transmitters” is selected by the user, the FM RDS receiver initially receives the transmitter without any audio signal (silence). At the same time—depending on the version—the IF signal or the audio identification is made available to the IRB. If the IRB now recognises a PS code which is identical to a currently active transmitter with a corresponding PS code, the IRB switches to the selected audio source or implements the corresponding menu function.

The “interactive RDS broadcast” communication offers the following advantages: The IRB does not have to interpret any control commands, but is based on conceptually static control information passed to it by the user. For this reason communication between the IRB and the user is clear and stable.

Moreover, the IRB operational concept can be put into practice in any FM RDS receiver independently of the manufacturer—for example also in domestic and mobile consumer electronics.

Moreover, a CAN (Controller Area Network) is not required to implement the IRB concept according to the invention and, furthermore, no software adaptations are required with regard to the different vehicle manufacturers.

Furthermore, no re-qualification of retrofitted vehicles is required. In addition, no operating element of the original FM RDS receiver is used for purposes other than intended or is given additional functions. This includes the advantage that intuitive operation and operator guidance is retained and station buttons can be used as in normal operation.

Moreover, the steering wheel remote control in the car retains its original functions. In addition, the remote controls in consumer electronics can also be used without any restrictions.

Furthermore, the device according to the invention and the method according to the invention do not require any limitation regarding a set number of favourites or storage space.

In addition, a dynamic arrangement of the transmitter list is possible. This means that it is still possible to select a transmitter by scrolling and paging down, and there is no need to switch from transmitter to transmitter—which is laborious and inconvenient for the user. Rather, one can change transmitter in any sequence without losing any time.

Furthermore, it is not necessary to fit any additional operating or display element, and the simple installation and integration of the method according to the invention can take place without any special configuration process.

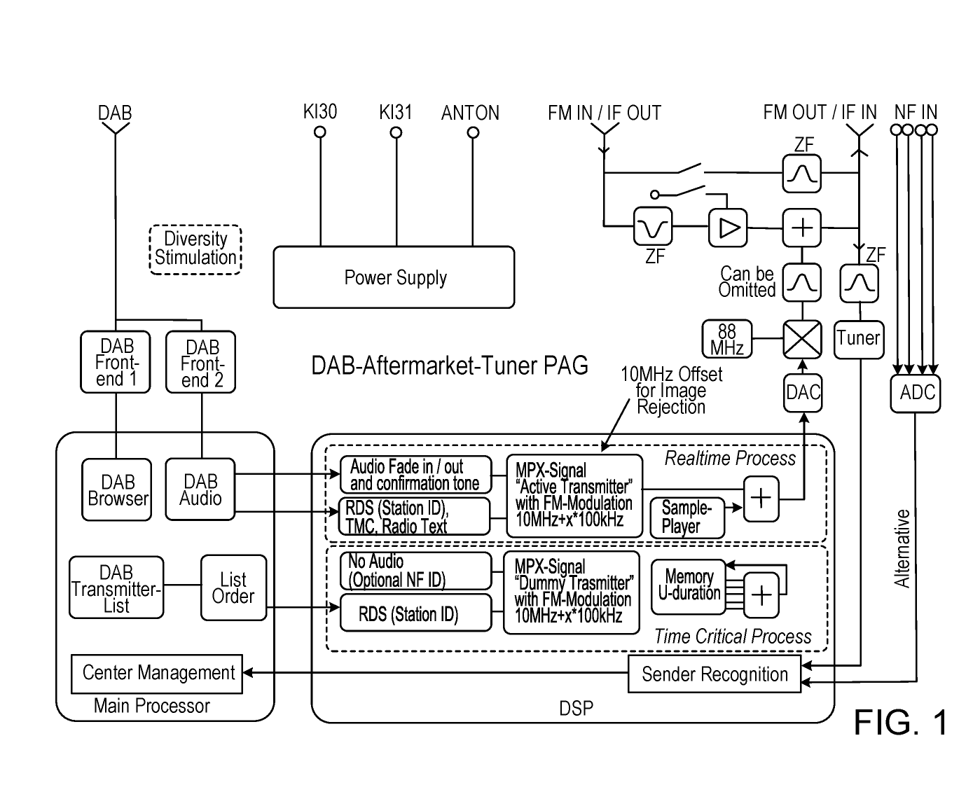

FIG. 1 shows the technical realisation/concept of a retrofitted DAB tuner by means of an FM RDS receiver with the “interactive RDS broadcast” operational concept.

There are a number of possibilities for the technical realisation of the actual DAB tuner and the front end, and in no case is it necessary to fit a special chip set. In order to implement the method according to the invention one should use a twin tuner that has the appropriate automotive capability and sufficient receiver sensitivity for use in motor vehicles.

The concept alternatives according to the invention basically make available at the very least the following interfaces:
a) digital audio data stream (stereo)
b) data services
c) communication interface for controlling the DAB tuner and for reading out the DAB transmitter list

Since the entire operation of the DAB tuner is realised via the RDS channel of the FM tuner in the PAG head unit, the following tasks must in turn be implemented in the software:

The DAB transmitter list must advantageously be sorted according to relevance. For this purpose every “transmitter” is recorded statistically. Accordingly, the longer a transmitter is listened to, the further up on the transmitter list the transmitter will appear. These statistics must also record transmitters that have not yet been received; this is important e.g. for commuters or for holiday journeys.

By means of the DAB transmitter list and the statistics the transmitter management determines the first n transmitters and assigns to each transmitter a frequency which should preferably always be the same.

In a subsequent step an MPX signal without audio is calculated for each of the first n transmitters. The RDS protocol is reduced here so that only the transmitter name is transmitted. For this reason the RDS data stream has a fixed length and duration (e.g. approx. 500 ms). The MPX signals are mathematically frequency-modulated with the set frequencies and are stored in the memory as “samples”. As a background activity a number of samples can be placed in the memory as being currently emitted (switch-over performance).

Some of these samples are permanently in the memory and have the following designations as the “transmitter name”

“-DAB-”, “-NEXT-”, “-FM-”, or “-CONFIG-”.

The n transmitters (samples) determined by the transmitter management are added up mathematically and are optionally deposited once again in the memory as a sum signal.

Independently of the samples, a real-time process computes an MPX signal with the DAB audio data including the RDS signal. This RDS signal should include radio text and selected data serves as TMC (Traffic Message Channel) information. The live MPX signal generated in this way is also mathematically frequency-modulated with the set frequency and is added to the sum signal of the samples from the memory in real-time.

A DAC (Digital Analogue Converter) generates an analogue signal from this digital data stream. With a mixer the signal is transposed into the FM frequency range, the following also being pointed out:

If the frequency from the DAC is kept over 10 MHz, due to the system the image frequencies of the mixer lie outside of the FM band. With a combiner the calculated FM signal is mixed with the received FM band and is delivered to the PAG head unit via the FM input. In order to avoid radiant emittances and retroactive effects on the FM antenna, under certain circumstances an amplifier is required that can also compensate for the damping of the combiner, the function of which is only required in order to mix the “-DAB-” sample into the previous FM operation.

In DAB operation the FM antenna is separated.

As a peculiarity of the PAG head unit, in FM operation the FM tuner must deliver the IF in the same FM antenna cable back to the antenna diversity of the vehicle.

Parallel to this, this IF signal can be evaluated. For this purpose the RDS information is made available again by a simple tuner. When the user is selecting a specific “transmitter” from his FM transmitting list during DAB operation, this RDS information corresponds exactly to transmitted RDS information. In this way it is communicated to the DAB module which transmitter the user wishes to listen to.

The transmitter management then sets the DAB tuner to this DAB transmitter and makes available the audio signal and the data services to the real-time MPX encoder without any clicking. By this time a new sum signal has already been calculated from the samples in the memory without the transmitter that is now active.

The user now listens to the selected transmitter. If the user selects, for example, the transmitter “-NEXT-”, the frequency of the active audio path changes to the “NEXT” frequency so that the audio listened to from the last transmitter can continue to be listened to. Furthermore, a new sum signal is calculated from the next n samples and is used.

Advantageously, statistics, transmitter management and the samples should be persistently administered so that upon start-up the last samples can be transmitted immediately.

The PLL (Phase Locked Loop) of the aforementioned tuner should preferably be of dimensions such that both the IF and the entire FM band can be received by the software.

Preferably, the FM antenna should be used as the DAB antenna by the hardware. Furthermore, the antenna diversity of the vehicle should preferably include adjustable amplitude with the aid of a 10.7 MHz oscillator.

Preferably, there should be the possibility of also being able to operate the DAB tuner without IF evaluation. For this purpose low-key identification can be included in the samples in the audio band, which identification is determined upon switching over at the final stage outputs.

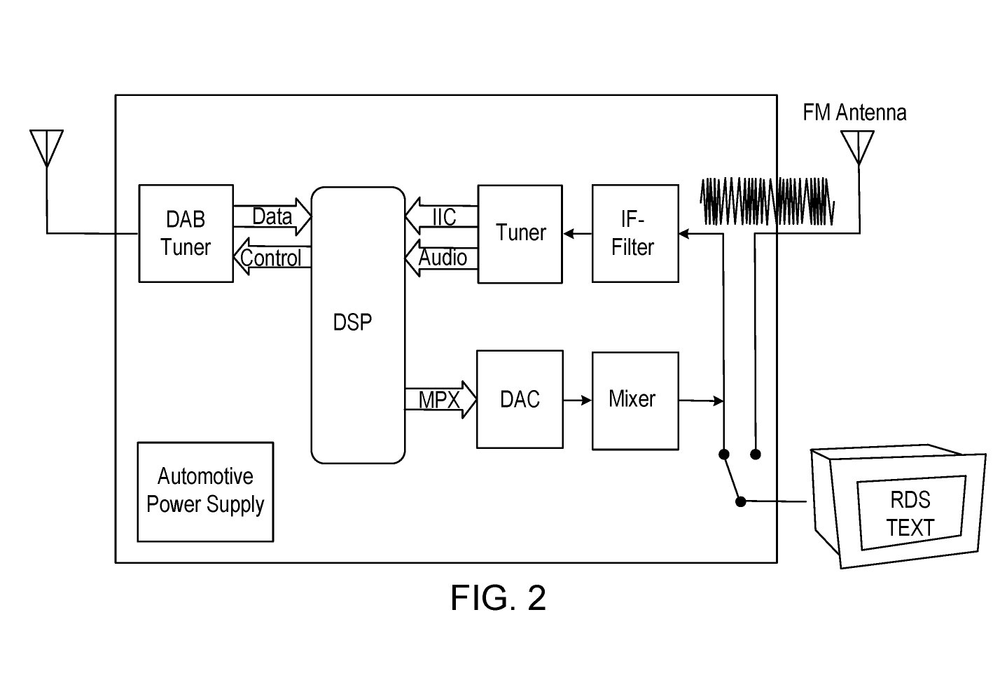

FIG. 2 shows a block diagram of a DAB receiver which has FM coupling to a head unit.

Technical Description

The DAB module for the retrofitting market consists essentially of a DAB receiver, a high-performance Digital Signal Processor (DSP), an FM tuner for the intermediate frequency (IF) coming from the head unit, and a power supply unit according to the automotive standard.

It is not necessary to use any additional hardware because operation of the receiver takes place with existing operating units—such as e.g. the operating part of the head unit.

The IF information that is available at the antenna input of many head units is used as the feedback channel. Alternatively, identification on the audio signal can be used as the return channel, by means of which the “interactive RDS broadcast” communication according to the invention can also be realised.

In order to switch over to DAB the head unit must be in the FM mode. The DAB module mixes into the FM antenna signal on a free frequency an FM signal without audio with the RDS information, e.g. “-DAB-”. This transmitter appears at the top of the FM transmitter list of the head unit because it has higher transmission power in comparison to the FM transmitter received via the antenna—or is preceded by a special sign in the case of an alphabetical sequence. The selected transmitter is contained as RDS information in the IF provided by the head unit at the antenna input and is available to the DSP via an IF filter and the tuner.

After the feedback of the selected transmitter has arrived at the DSP, the module switches over to the DAB mode. In this situation the FM antenna is deactivated and n transmitters from the DAB transmitter list are transmitted to the head unit without audio with a defined frequency and DAB information (transmitter name from the DAB tuner). The DSP once again receives via the IF the return signal indicating which transmitter is selected and activates the audio signal for this transmitter. The user is thereby given the impression that the head unit in the DAB mode behaves in exactly the same way as it previously behaved in the FM mode.

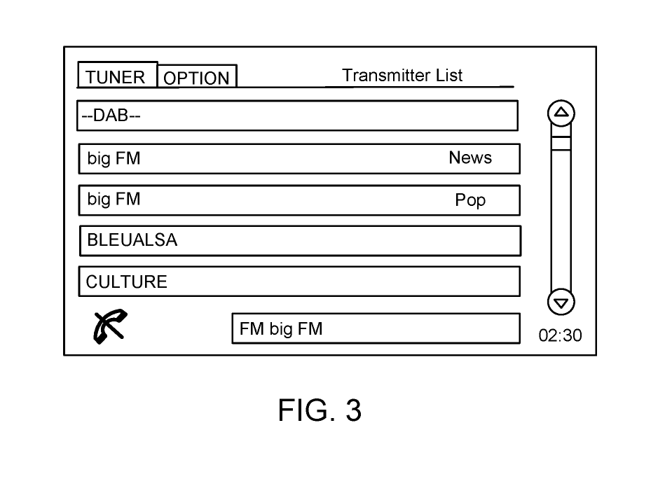

FIG. 3 shows “-DAB-” as the transmitter in the FM transmitter list according to an operational concept. In the FM transmitter list the user finds another transmitter with the designation --DAB--. By selecting this transmitter one switches over to the DAB mode.

A new transmitter list is compiled with the first n (e.g. n=10) transmitters that are received via DAB. --FM-- now appears at the top of the new transmitter list in order to be able to switch back to the FM mode again. The information “-NEXT-” appears in second position in order to display the next n transmitters. In a preferred embodiment the transmitters which are offered in the transmitter list can also be stored on station buttons—as in FM operation.

There are various uses for the operational concept. Instead of the DAB receiver, any audio module—be it analogue or digital—(such as e.g. SDARS (Satellite Digital Audio Radio Services), tuners, MP3 players etc.) can be used.

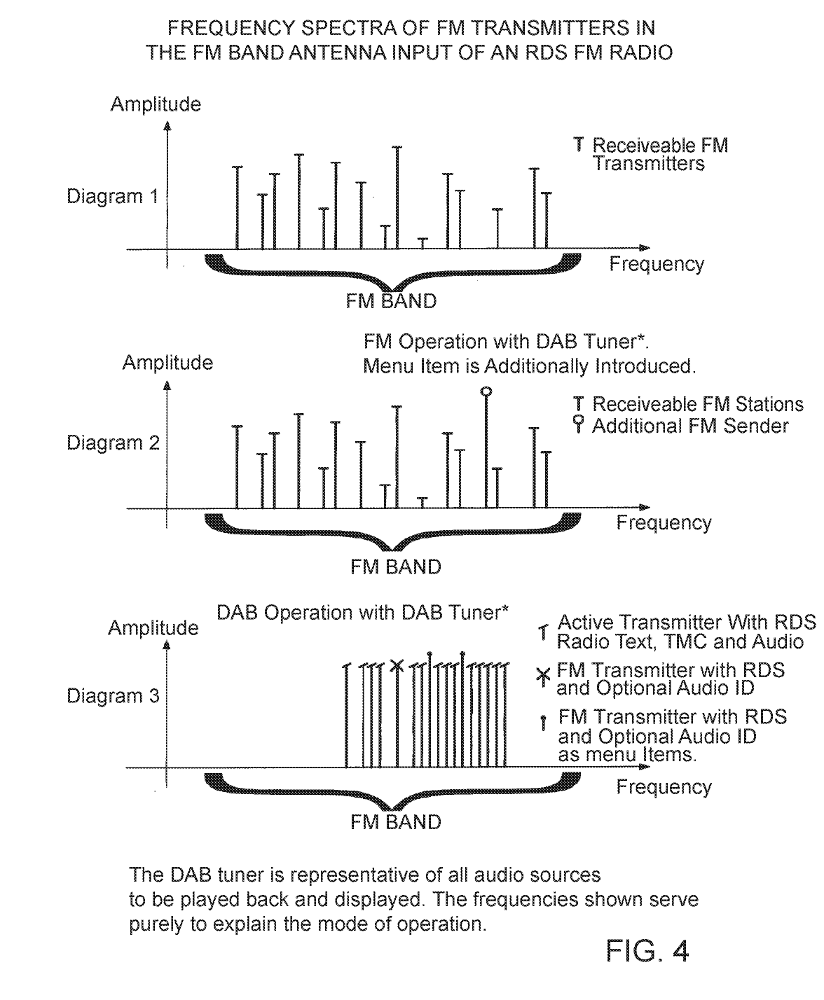

FIG. 4 shows frequency spectra of FM transmitters in the VHF band at the antenna input of an RDS FM radio.

In summary, the present invention according to the first embodiment relates to a method of presenting, preferably for receiving, emitting and displaying digital received signals, preferably DAB received signals, on a first receiver provided to receive analogue receiver signals, that has the following steps:

a) providing at least one additional receiver channel in a transmitter list of the first receiver, the additional receiver channel being assigned to the digital received signals;

b) generating the additional receiver channel by means of a second receiver provided in addition to the first receiver, which second receiver receives digital received signals and provides analogue received signals for the first receiver; and

c) selecting the digital received signals at the first receiver.

Secondly, the present invention, preferably in a method version of the first embodiment, relates to a method in which, after selecting the additional receiver channel at the first receiver, a number of analogue receiver channels are generated by the second receiver for the first receiver.

Thirdly, the present invention preferably relates to a method version of the above second version in which one receiver channel of the number of analogue receiver channels contains the audio information, and the other analogue receiver channels are presented in the transmitter list of the first receiver channel without any audio information.

In another—fourth—method version the present invention particularly preferably relates to a method according to either the second or the third method version in which the number of analogue receiver channels generated by the second receiver correspond to the digital input channels.

In another version the present invention relates to a method according to any of the aforementioned first embodiment or of all of the method versions listed in which the first receiver is an FM RDS radio receiver and the second receiver is a DAB receiver and/or some other digital audio source.

In addition, the present invention relates to a device for presenting, preferably for receiving, emitting and displaying digital received signals, preferably using the method according to any of the versions or the embodiment described above, consisting of a first receiver for selecting receiver channels, a second receiver for receiving digital receiver channels, which is delivered to the first receiver in order to select the receiver channels.

Furthermore, the present invention preferably relates to the device identified above in which a switchover device is provided, preferably in the second receiver, which switchover device, after selecting the additional receiver channel, switches over receipt of the analogue received signals to receipt of digital received signals and/or vice versa and/or from the first receiver to the second receiver and vice versa.

Key to FIG. 1:

Senderliste=transmitter list

Listensortierung=list sorting

Sendermanagement=transmitter management

Mainprozessor=main processor

Kann entfallen=may be omitted

ZF=IF (Intermediate Frequency)

NF=LF (Low Frequency)

DAB Nachrüst-Tuner=DAB retrofitted tuner

10 MHz Offset für Spiegelfrequenzunterdrückung=10 MHz offset for image frequency suppression

und Quittierungston=and acknowledgement tone

Senderkennung=transmitter identification

Radiotext=radio text

Keine Audio (optional NF-Kennung=no audio (optional LF identification)

“aktiver Sender” mit FM-Modulation=“active transmitter” with FM modulation

“Dummy Sender” mit FM-Modulation=“dummy transmitter” with FM modulation

Realtime Prozess=real-time process

Speicher=memory

U-Dauer=U-duration

Zeitunkritischer Prozess=non-time-critical process

Alternativ =alternative

Ersatzblatt/Regel=replacement page/rule

Key to FIG. 2:

ZF=IF (Intermediate Frequency)

Ersatzblatt/Regel=replacement page/rule

Key to FIG. 3:

Senderliste=transmitter list

Ersatzblatt/Rege =replacement page/rule

Key to FIG. 4:

Frequenzspektrum FM-Sender im UKW-Band am Antenneneingang eines RDS-FM-Radios=frequency spectrum FM transmitter in the VHS band at the antenna input of an RDS FM radio

Beispiel FM-Sender ohne DAB-Tuner=example of FM transmitter without DAB tuner

Diagramm=diagram

Empfangbare FM-Sender=receivable FM transmitters

Frequenz=frequency

UKW-Band=VHF band

FM-Betrieb mit DAB-Tuner. Menüpunkt wird zusätzlich eingefügt=FM operation with DAB tuner. Menu item is additionally added

Zusätzlicher FM-Sender=additional FM transmitter

DAB-Betrieb mit DAB-Tuner=DAB operation with DAB tuner

Aktiver Sender mit RDS, Radiotext, TMC und Audio=active transmitter with RDS, radio text, TMC and audio

FM-Sender mit RDS und ggf. Audio-Kennung als Menüpunkte=

FM transmitter with RDS and optionally audio identification as menu items

Der DAB-Tuner steht stellvertretend far all abzuspielenden und anzuzeigenden Audioquellen. Die dargestellten Frequenzen dienen lediglich der Erklärung der Funktionsweise=The DAB tuner is representative of all audio sources to be played back and displayed. The frequencies shown serve purely to explain the mode of operation

Ersatzblatt/Regel=replacement page/rule

1. A method of presenting, preferably of receiving, emitting and displaying digital received signals, preferably DAB received signals, on a first receiver provided to receive analogue receiver signals, that has the following steps:
a) providing at least one additional receiver channel in a transmitter list of the first receiver, the additional receiver channel being assigned to the digital received signals;
b) generating the additional receiver channel by means of a second receiver provided in addition to the first receiver, which second receiver receives digital received signals and provides analogue received signals for the first receiver; and
c) selecting the digital received signals at the first receiver.

2. The method according to claim 1, characterised in that, after selecting the additional receiver channel at the first receiver, a number of analogue receiver channels are generated by the second receiver for the first receiver.

3. The method according to claim 2, characterised in that one receiver channel of the number of analogue receiver channels contains the audio information and the other analogue receiver channels are presented in the transmitter list of the first receiver channel without any audio information.

4. The method according to claim 2, characterised in that the number of analogue receiver channels generated by the second receiver correspond to the digital input channels.

5. The method according to claim 1, characterised in that the first receiver is an FM RDS radio receiver and the second receiver is a DAB receiver and/or some other digital audio source.

6. A device for presenting, preferably for receiving, emitting and displaying digital received signals, using the method according to claim 1, consisting of a first receiver for selecting receiver channels, a second receiver for receiving digital receiver channels, which is delivered to the first receiver in order to select the receiver channels.

7. The device according to claim 6, characterised in that a switchover device is provided, preferably in the second receiver, which switchover device, after selecting the additional receiver channel, switches over receipt of the analogue received signals to receipt of digital received signals and/or vice versa and/or from the first receiver to the second receiver and vice versa.

8. The method according to claim 3, characterised in that the number of analogue receiver channels generated by the second receiver correspond to the digital input channels.

9. The method according to claim 2, characterised in that the first receiver is an FM RDS radio receiver and the second receiver is a DAB receiver and/or some other digital audio source.

10. The method according to claim 3, characterised in that the first receiver is an FM RDS radio receiver and the second receiver is a DAB receiver and/or some other digital audio source.

11. The method according to claim 4, characterised in that the first receiver is an FM RDS radio receiver and the second receiver is a DAB receiver and/or some other digital audio source.

12. A device for presenting, preferably for receiving, emitting and displaying digital received signals, using the method according to claim 2, consisting of a first receiver for selecting receiver channels, a second receiver for receiving digital receiver channels, which is delivered to the first receiver in order to select the receiver channels.

13. A device for presenting, preferably for receiving, emitting and displaying digital received signals, using the method according to claim 3, consisting of a first receiver for selecting receiver channels, a second receiver for receiving digital receiver channels, which is delivered to the first receiver in order to select the receiver channels.

14. A device for presenting, preferably for receiving, emitting and displaying digital received signals, using the method according to claim 4, consisting of a first receiver for selecting receiver channels, a second receiver for receiving digital receiver channels, which is delivered to the first receiver in order to select the receiver channels.

15. A device for presenting, preferably for receiving, emitting and displaying digital received signals, using the method according to claim 5, consisting of a first receiver for selecting receiver channels, a second receiver for receiving digital receiver channels, which is delivered to the first receiver in order to select the receiver channels.
